(19) United States
(12) Patent Application Publication
(10) Pub. No.: US 2006/0217166 A1
(43) Pub. Date: Sep. 28, 2006

(54) Portable radio, and method for conveying information

(76) Inventor: Christian R. Swanson, Los Angeles, CA (US)

Correspondence Address: LAW OFFICES OF ERIC KARICH, 2807 ST. MARK DR., MANSFIELD, TX, 76063, US

(21) Appl. No.: 11/086,096

(22) Filed: Mar. 22, 2005

(51) Int. Cl. H04B 1/10

(52) U.S. Cl. 455/701

(57) ABSTRACT

A portable radio is disclosed including transmit circuitry coupled to an antenna, and channel selection circuitry coupled to the transmit circuitry. The transmit circuitry receives transmit channel information, and is configured to selectively transmit on one of multiple radio frequency channels dependent upon the transmit channel information. The channel selection circuitry receives a sequence of audible tones conveying the transmit channel information, decodes the sequence of audible tones to produce the transmit channel information, and provides the transmit channel information to the transmitter circuitry. A described method of conveying information includes decoding at least a portion of a license plate number to identify a radio frequency channel, and transmitting a radio frequency signal conveying the information on the radio frequency channel.

### CROSS-REFERENCE TO RELATED APPLICATIONS

Not Applicable

### BACKGROUND OF THE INVENTION

1. Field of the Invention

This invention relates generally to communication systems, and more particularly to radio communication systems.

2. Description of Related Art

The radio spectrum is the part of the natural spectrum of electromagnetic radiation having frequencies between 9 kilohertz (kHz) and 300 gigahertz (GHz). In the United States, regulatory responsibility for the radio spectrum is divided between the Federal Communications Commission (FCC) and the National Telecommunications and Information Administration (NTIA). The FCC administers spectrum use for non-government agencies, and the NTIA administers spectrum use for government agencies.

Wireless services administered by the FCC Wireless Telecommunications Bureau and geared toward two-way voice communication include the citizens band (CB) radio service, the family radio service (FRS), and the general mobile radio service (GMRS).

The CB radio service is a private two-way voice communication service for use in personal and business activities of the general public. CB radio communications typically range from one to five miles. No license is required to operate a CB radio (in places where the FCC regulates radio communications). The CB radio service uses 40 specific frequencies (i.e., channels) in the high frequency (HF) band.

The FRS is one of the CB radio services. FRS radios are typically used by family, friends, and associates to communicate within a relatively small local area. FRS radios may also be used for business-related communications. No license is required to operate an FRS radio (in places where the FCC regulates radio communications). The FRS uses 14 specific frequencies (i.e., channels) in the ultra high frequency (UHF) band.

The GMRS is a land mobile radio service available for short distance, two-way communications to facilitate the activities of an adult individual and his or her immediate family members. The FCC grants five year renewable licenses for GMRS systems. The GMRS includes 7 frequencies (i.e., channels) shared with the FRS, plus 16 additional channels in the UHF band.

In radio communication systems, a squelch is a circuit function that acts to suppress the audio output of a receiver. The squelch function may be, for example, activated in the absence of a sufficiently strong desired input signal in order to quiet the receiver. Most FRS and GMRS radios uses the continuous tone coded squelch system (CTCSS). The CTCSS establishes 51 “sub-audible” tones from 67.0 to 250.3 hertz (Hz). In radio communication systems, the term “sub-audible” is applied to signals having frequencies below 300 Hz. CTCSS tones are commonly referred to as “squelch tones.” Many FRS radios use only 38 of the available 51 CTCSS squelch tones.

A squelch circuit of a receiver using CTCSS can be considered either “open” or “closed.” A transmitter transmitting on a particular channel (i.e., frequency) using CTCSS includes one of the CTCSS squelch tones in each transmission. A squelch circuit of a receiver tuned to the same channel will not open unless a specific one of the CTCSS squelch tones is received. If the CTCSS squelch tone of the transmitter matches the CTCSS squelch tone of the receiver, the squelch circuit will open, allowing the transmission to be received. If, on the other hand, the CTCSS squelch tone of the transmitter does not match the CTCSS squelch tone of the receiver, the squelch circuit remains closed, and the receiver remains quiet.

When the 14 FRS channels are combined with 38 CTCSS tones, a total of 532 “sub-channels” are available on many FRS radios. (In theory, the 14 FRS channels may be combined with the 51 CTCSS tones, producing a total of 714 sub-channels.)

FRS radios are often used to communicate between two or more vehicles traveling to the same destination. In order to do so, the occupants of the vehicles typically decide beforehand on a common channel and CTCSS squelch tone. With hundreds of possible channel and CTCSS squelch tone combinations, occupants of vehicles in different groups seldom choose the same channel and CTCSS squelch tone. By the same token, it is difficult for occupants in two different vehicles to communicate via FRS radios unless an occupant in one of the vehicles somehow communicates his or her channel number and CTCSS squelch tone to an occupant in the other vehicle.

It would be advantageous to have a method of determining a channel and/or squelch code of a portable radio within a vehicle based on a visual property of the vehicle. It would also be advantageous to have a portable radio that can easily be programmed to a particular channel and/or squelch tone corresponding to such a visual property. The method and/or portable radio would allow someone else to communicate with an occupant of the vehicle via a similar radio quickly and easily.

### SUMMARY OF THE INVENTION

A portable radio is disclosed including transmit circuitry coupled to an antenna, and channel selection circuitry coupled to the transmit circuitry. The transmit circuitry receives transmit channel information, and is configured to selectively transmit on one of multiple radio frequency channels dependent upon the transmit channel information. The channel selection circuitry receives a sequence of audible tones conveying the transmit channel information, decodes the sequence of audible tones to produce the transmit channel information, and provides the transmit channel information to the transmitter circuitry. A described method of conveying information includes decoding at least a portion of a license plate number to identify a radio frequency channel, and transmitting a radio frequency signal conveying information on the radio frequency channel.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 depicts the use of a portable radio by a user in one automobile to convey information to an occupant of another automobile having another portable radio;

FIG. 2 is a front view of one embodiment of the portable radio of FIG. 1; and

FIG. 3 is a block diagram of a portion of one embodiment of the portable radio of FIGS. 1 and 2.

### DETAILED DESCRIPTION OF THE INVENTION

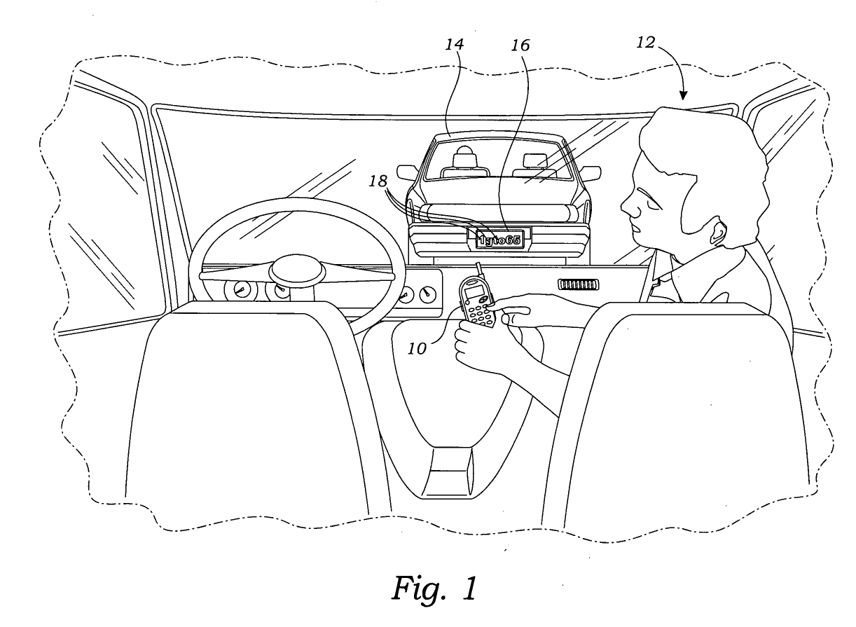

FIG. 1 depicts the use of a portable radio 10 by a user 12 in one automobile to convey information to an occupant of another automobile 14 having another portable radio. In general, the portable radio 10 is capable of transmitting a modulated radio frequency signal on a selected one of several different radio frequency channels, and the other portable radio is capable of receiving modulated radio frequency signals on a selected one of the several different radio frequency channels. The other portable radio may be similar to the portable radio 10.

In FIG. 1, the user 12 can see a license plate 16 of the other automobile 14. As is typical, the license plate 16 has a sequence of alphanumeric characters 18 printed on it. The other portable radio is configured to receive radio frequency signals transmitted on a first radio frequency channel, wherein the first frequency channel corresponds to at least a portion of the license plate number formed by the alphanumeric characters 18.

Herein below, the at least a portion of the license plate number formed by the alphanumeric characters 18 will be referred to as “the designated portion of the license plate number.” In the preferred embodiment, the designated portion of the license plate number includes the last three alphanumeric characters 18 of the license plate number, although other portions and other numbers of characters could also be used in alternative embodiments.

During the conveying of the information, the designated portion of the license plate number is decoded to identify the first radio frequency channel, and the user 10 transmits a radio frequency signal conveying information on the first radio frequency channel. In a preferred embodiment, the portable radio 10 includes an alphanumeric keypad and channel selection circuitry coupled to the keypad. The channel selection circuitry is configured to use information from the keypad to identify the first radio frequency channel. The user 12 enters the designated portion of the license plate number via the keypad. The channel selection circuitry decodes the information from the keypad to identify the first radio frequency channel, and signals transmit circuitry to tune to the first frequency channel. Alternately, the user 12 may use a printed chart or table to use the designated portion of the license plate number to identify the first radio frequency channel.

In general, the portable radio 10 is configured to receive radio frequency signals transmitted on a second radio frequency channel. As described in more detail below, the information conveyed by the radio frequency signal transmitted by the portable radio 10 may include transmit channel information identifying the second radio frequency channel. In the preferred embodiment, and as described in more detail below, the radio frequency signal preferably conveys an audio signal, and the audio signal includes a sequence of audible tones identifying the second radio frequency channel. The other portable radio includes transmit circuitry and other circuitry to decode the audible tones and to automatically tune to the transmit circuitry to the second frequency channel. Alternately, the user 12 may disclose the second radio frequency channel to the occupant of the other vehicle, and the occupant of the other vehicle may tune the transmit circuitry of the other portable radio to the second frequency channel.

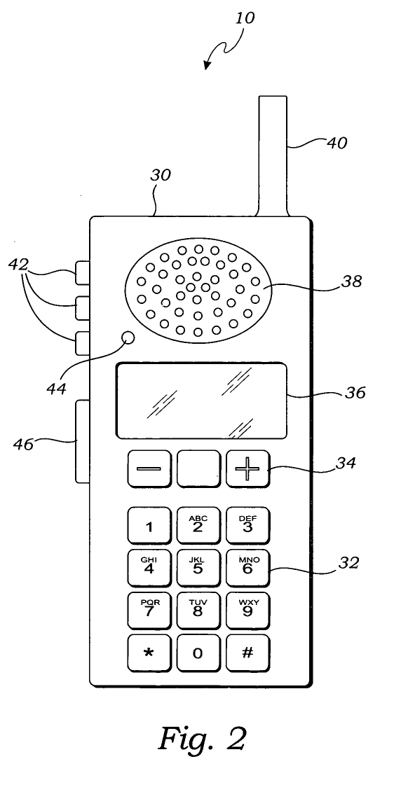

FIG. 2 is a front view of one embodiment of the portable radio 10 of FIG. 1. In the embodiment of FIG. 2, the portable radio 10 includes a case 30, an alphanumeric keypad 32, several pushbutton switches 34 for accessing a menu function and selecting from a displayed menu, a display screen 36, a speaker 38 behind an array of holes in the case 30, an antenna 40 protruding from the case 30, several more pushbutton switches 42 for operating the portable radio 10, a microphone 44, and a push to talk (PTT) pushbutton switch 46 for activating transmit circuitry of the portable radio 10. All of the components of the portable radio 10 shown in FIG. 2 are known and commercially available.

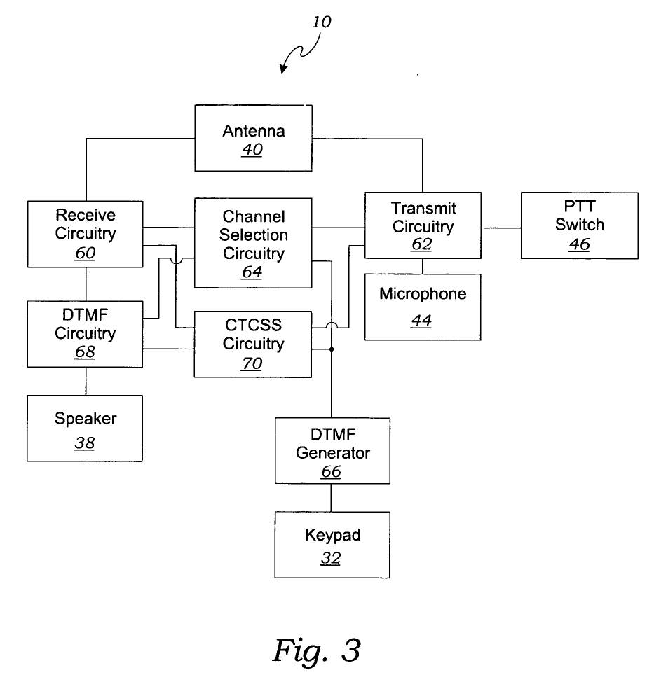

FIG. 3 is a block diagram of a portion of one embodiment of the portable radio 10 of FIGS. 1 and 2. Components of the portable radio 10 shown in FIG. 2 and described above are labeled similarly in FIG. 3. In the embodiment of FIG. 3, in addition to the alphanumeric keypad 32, the speaker 38, the antenna 40, the microphone 44, and the PTT switch 46, the portion of the portable radio 10 also includes receive circuitry 60, transmit circuitry 62, channel selection circuitry 64, a dual tone multi-frequency (DTMF) generator 66, a DTMF decoder 68, and continuous tone coded squelch system (CTCSS) circuitry 70.

As described above, the portable radio 10 is capable of transmitting a modulated radio frequency signal on a selected one of several different radio frequency channels. In the embodiment of FIG. 3, the transmit circuitry 62 is coupled to the antenna 40, the channel selection circuitry 64, the CTCSS circuitry 70, the microphone 44, and the PTT switch 46. In general, the transmit circuitry 62 receives transmit channel information from the channel selection circuitry 64, and transmits a modulated radio frequency signal on one of the several different radio frequency channels dependent upon the transmit channel information when the PTT switch 46 is pressed. The transmit circuitry 60 receives a squelch code signal indicative of a squelch code from the CTCSS circuitry 70, and transmits squelch code information indicative of the squelch code at the beginning of each transmission. The transmit circuitry 62 may, for example, transmit on one of the frequencies (i.e., channels) assigned to the citizens band (CB) radio service, the family radio service (FRS), or the general mobile radio service (GMRS).

The portable radio 10 is capable of receiving a modulated radio frequency signal on a selected one of the several different radio frequency channels. In the embodiment of FIG. 3, the receive circuitry 60 is coupled to the antenna 40, the channel selection circuitry 64, the CTCSS circuitry 70, and the DTMF detector 68. In general, the receive circuitry 60 receives receive channel information from the channel selection circuitry 64, and receives on one of the several different radio frequency channels dependent upon the receive channel information.

In general, the receive circuitry 60 receives a modulated radio frequency signal on one of the several different radio frequency channels dependent upon the receive channel information, and selectively demodulates the modulated radio frequency signal to produce an audio signal. More specifically, the receive circuitry 60 receives a squelch code signal indicative of a squelch code from the CTCSS circuitry 70, and demodulates the modulated radio frequency signal to produce the audio signal only if the modulated radio frequency signal conveys the squelch code. The receive circuitry 60 may, for example, receive on one of the frequencies (i.e., channels) assigned to the citizens band (CB) radio service, the family radio service (FRS), or the general mobile radio service (GMRS).

The DTMF generator 66 is coupled to the keypad 32, the channel selection circuitry 64, and the CTCSS circuitry 70. The keypad 32 is preferably a standard telephone keypad (i.e., a DTMF keypad). The DTMF generator 66 is in general tone generation circuitry that produces DTMF tone pairs in response to user input via the keypad 32. In general, each sequence of audible DTMF tone pairs produced by the DTMF generator 66 identifies a particular one of the several different radio frequency channels, and a particular one of several different sub-audible CTCSS squelch tones.

During initialization of the portable radio, the DTMF generator 66 produces a first sequence of audible DTMF tone pairs, and provides the first sequence of audible DTMF tone pairs to the channel selection circuitry 64 and to the CTCSS circuitry 70. In general, the first sequence of audible DTMF tone pairs conveys the receive channel information and the corresponding squelch code.

The first sequence of audible DTMF tone pairs is preferably produced when the user enters the designated portion of the license plate number printed on the license plate attached to his or her automobile via the keypad 32. In this situation, the portable radio 10 is configured to receive radio frequency signals transmitted on a radio frequency channel corresponding to the designated portion of the license plate number of the user's automobile.

The channel selection circuitry 64 receives the first sequence of audible DTMF tone pairs from the DTMF generator 66, decodes the first sequence of audible DTMF tone pairs to produce the receive channel information, and provides the receive channel information to the receive circuitry 60. The CTCSS circuitry 70 also receives the first sequence of audible DTMF tone pairs from the DTMF generator 66, decodes the first sequence of audible DTMF tone pairs to produce a squelch code, and provides the squelch code to the receive circuitry 60.

During operation of the portable radio 10, the DTMF generator 66 produces a second sequence of audible DTMF tone pairs, and provides the second sequence of audible DTMF tone pairs to the channel selection circuitry 64 and to the CTCSS circuitry 70. The second sequence of audible DTMF tone pairs is preferably produced when the user enters the designated portion of the license plate number of another automobile (e.g., the other automobile 14 in FIG. 1) via the keypad 32. In general, the second sequence of audible DTMF tone pairs conveys transmit channel information indicative of a first transmit channel.

The channel selection circuitry 64 receives the second sequence of audible DTMF tone pairs from the DTMF generator 66, decodes the second sequence of audible DTMF tone pairs to produce transmit channel information indicative of a first transmit channel, and provides the transmit channel information indicative of the first transmit channel to the transmit circuitry 62 as the transmit channel information. The CTCSS circuitry 70 also receives the second sequence of audible DTMF tone pairs from the DTMF generator 66, decodes the second sequence of audible DTMF tone pairs to produce a squelch code corresponding to the first transmit channel, and provides the squelch code to the transmit circuitry 62.

In the embodiment of FIG. 3, the DTMF detector 68 is coupled to the receive circuitry 60, the channel selection circuitry 64, the CTCSS circuitry 70, and to the speaker 38. The DTMF detector 68 generally functions as a tone detector. The receive circuitry selectively demodulates a modulated radio frequency signal to produce an audio signal, and provides the audio signal to the DTMF detector 68. In general, the DTMF detector 68 provides the audio signal to the speaker 38, and detects any audible DTMF tone pairs within the audio signal.

In a preferred embodiment, the audio signal includes a third sequence of audible DTMF tone pairs conveying transmit channel information indicative of a second transmit channel. The channel selection circuitry 64 receives the third sequence of audible DTMF tone pairs, decodes the third sequence of audible DTMF tone pairs to produce transmit channel information indicative of the second transmit channel, and provides the transmit channel information indicative of the second transmit channel to the transmit circuitry 62 as the transmit channel information. As a result, the transmit circuitry 62 advantageously automatically tunes to the second transmit channel. The CTCSS circuitry 70 also receives the third sequence of audible DTMF tone pairs from the DTMF detector 68, decodes the second sequence of audible DTMF tone pairs to produce a squelch code corresponding to the second transmit channel, and provides the squelch code to the transmit circuitry 62.

The third sequence of audible DTMF tone pairs may advantageously be positioned at an end of the audio signal, and may also function as a “roger beep.” In general, a roger beep is an audible tone or sound that lets a receiver know when an incoming transmission has ended.

In one embodiment, the designated portion of the license plate number is the last 3 alphanumeric characters 18 of the license plate number. Table 1 below lists several possible last 3 alphanumeric character sequences of a license plate number of a vehicle and possible corresponding receive channel numbers and CTCSS squelch tones of a portable radio (e.g., the portable radio 10 of FIGS. 1-3) carried within the vehicle.

TABLE 1
Last 3 Alphanumeric Characters of a License Plate Number
of a Vehicle and Corresponding Receive Channel Number
and CTCSS Code of a Portable Radio Carried in the Vehicle.

| | Receive | Receive | DTMF Keypad |
|---|---|---|---|
| Last 3 Characters | Channel Number | CTCSS Code | Entry Sequence |
| 000 | 1 | 1 | 000 |
| 001 | 1 | 1 | 001 |
| 002 | 1 | 2 | 002 |
| 00A | 1 | 2 | 002 |
| 00B | 1 | 2 | 002 |
| 00C | 1 | 2 | 002 |
| 003 | 1 | 3 | 003 |
| 00D | 1 | 3 | 003 |
| 00E | 1 | 3 | 003 |
| 00F | 1 | 3 | 003 |
| 004 | 1 | 4 | 004 |
| 00G | 1 | 4 | 004 |
| 00H | 1 | 4 | 004 |
| 00I | 1 | 4 | 004 |
| 005 | 1 | 5 | 005 |
| 00J | 1 | 5 | 005 |
| 00K | 1 | 5 | 005 |
| 00L | 1 | 5 | 005 |

In Table 1 above, the mapping of last 3 alphanumeric character sequences to receive channel numbers and CTCSS squelch tones is primarily driven by corresponding DTMF keypad entry sequences (also provided in Table 1). That is, all character sequences having identical corresponding DTMF keypad entry sequences map to the same receive channel number and CTCSS code. For example, in Table 1 above, the character sequences “002,” “00A,” “00B,” and “00C” have identical corresponding DTMF keypad entry sequences, and all four sequences map to receive channel number 1 and CTCSS code 2.

It is noted that audible signals other than DTMF tones may also be used to convey the transmit channel information, the receive channel information, and squelch tones. It is also noted that squelch systems other than the CTCSS may also be used.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A portable radio, comprising:
transmit circuitry coupled to an antenna and to receive transmit channel information, wherein the transmit circuitry is configured to selectively transmit on one of a plurality of radio frequency channels dependent upon the transmit channel information; and
channel selection circuitry coupled to the transmit circuitry and to receive a sequence of audible tones conveying the transmit channel information, wherein the channel selection circuitry is configured to decode the sequence of audible tones to produce the transmit channel information, and to provide the transmit channel information to the transmitter circuitry.

2. The portable radio as recited in claim 1, wherein the sequence of audible tones comprises a sequence of dual tone multi-frequency (DTMF) tone pairs.

3. The portable radio as recited in claim 1, wherein the sequence of audible tones identifies a particular one of the plurality of radio frequency channels.

4. The portable radio as recited in claim 1, further comprising tone generation circuitry coupled to the channel selection circuitry and configured to produce the sequence of audible tones in response to user input.

5. A portable radio, comprising:
transmit circuitry coupled to an antenna and to receive transmit channel information, wherein the transmit circuitry is configured to selectively transmit on one of a plurality of radio frequency channels dependent upon the transmit channel information;
receive circuitry coupled to the antenna and to receive receive channel information, wherein the receive circuitry is configured to receive on one of the plurality of radio frequency channels dependent upon the receive channel information;
tone generation circuitry configured to produce:
a first sequence of audible tones in response to user input during initialization of the portable radio, wherein the first sequence of audible tones conveys the receive channel information;
a second sequence of audible tones in response to user input during operation of the portable radio, wherein the second sequence of audible tones conveys transmit channel information indicative of a first transmit channel;
channel selection circuitry coupled to receive the first and second sequences of audible tones from the tone detection circuitry, and wherein the channel selection circuitry is configured to:
decode the first sequence of audible tones to produce the receive channel information, and to provide the receive channel information to the receive circuitry; and
decode the second sequence of audible tones to produce transmit channel information indicative of a first transmit channel, and to provide the transmit channel information indicative of the first transmit channel to the transmit circuitry as the transmit channel information.

6. The portable radio as recited in claim 5, wherein the receive circuitry is configured to receive a modulated radio frequency signal on one of the plurality of radio frequency channels dependent upon the receive channel information, and to demodulate the modulated radio frequency signal to produce an audio signal, wherein the audio signal comprises a third sequence of audible tones conveying transmit channel information indicative of a second transmit channel.

7. The portable radio as recited in claim 6, wherein the channel selection circuitry is coupled to receive the third sequence of audible tones, and configured to decode the third sequence of audible tones to produce transmit channel information indicative of a second transmit channel, and to provide the transmit channel information indicative of the second transmit channel to the transmitter circuitry as the transmit channel information.

8. The portable radio as recited in claim 6, wherein the receive circuitry is coupled to receive a squelch code signal indicative of a squelch code, and wherein the receive circuitry is configured to demodulate the modulated radio frequency signal to produce the audio signal only if the modulated radio frequency signal conveys the squelch code.

9. A method of conveying information, comprising:
decoding at least a portion of a license plate number to identify a first radio frequency channel; and
transmitting a radio frequency signal conveying the information on the first radio frequency channel.

10. The method as recited in claim 9, wherein the license plate number comprises a series of alphanumeric characters printed on a license plate.

11. The method as recited in claim 10, wherein the license plate is attached to a motor vehicle.

12. The method as recited in claim 11, wherein the motor vehicle comprises at least one occupant, and wherein the information conveyed by the radio frequency signal identifies a second radio frequency channel, and wherein the at least one occupant has a radio receiver configurable to transmit on the second radio frequency channel in response to the received information.

13. The method as recited in claim 12, wherein the radio frequency signal comprises an audio signal, and wherein the audio signal comprises a sequence of audible tones identifying the second radio frequency channel.
